(19) United States
(12) Patent Application Publication
(10) Pub. No.: US 2015/0285383 A1
(43) Pub. Date: Oct. 8, 2015

(54) Block-and-Bleed Fluid Regulating

(71) Applicant: Woodward, Inc., Fort Collins, CO (US)

(72) Inventors: Steven Charles Stumbo, Severance, CO (US); Jeffrey Taylor Stewart, Greeley, CO (US)

(73) Assignee: Woodward, Inc., Fort Collins, CO (US)

(21) Appl. No.: 14/246,734

(22) Filed: Apr. 7, 2014

(51) Int. Cl. F16K 1/44

(52) U.S. Cl. CPC F16K 1/446

(57) ABSTRACT

A block valve includes a valve body having an interior chamber between an inlet port and an outlet port, with the valve body including a vent port positioned in the valve body. The block valve further includes a valve closure element located within the chamber, with the valve closure element having a fluid passage therethrough. The valve closure element is movable relative to the valve body between a first position, where the fluid passage is at least partially alignable with the inlet port and the outlet port, and a second position, where a sealing surface of the valve closure element seals the inlet port and the outlet port from the chamber. The valve closure element includes a vent channel positioned in fluid communication with the vent port and the fluid passage of the valve closure element.

### TECHNICAL FIELD

This disclosure generally relates to a block valve for regulating fluid through a fluid system and more particularly a block valve with a pressure and fluid bleed feature.

### BACKGROUND

Block-and-bleed valves are used to isolate or block the flow of fluid in a fluid system, so the fluid from upstream of the valve does not reach other components of the system that are downstream, then bleed off or vent the remaining fluid from the system on the downstream side of the valve. Double-block-and bleed valve systems operate on the principle that isolation can be achieved from both the upstream and downstream process flow/pressures. Typically, to provide a double-block-and-bleed valve system, two control or stop valves are used in series with a third vent valve positioned between them. When the two control and/or stop valves are closed, the vent valve can be opened to relieve any residual pressure and/or leakage.

### BRIEF DESCRIPTION OF THE DRAWINGS

FIG. 1A is a perspective view from the side of a double-block-and-bleed valve.

FIG. 1B is a perspective view from above of a valve closure element of the double-block-and-bleed valve of FIG. 1A.

FIG. 2A is a perspective cross-section view of the double-block-and-bleed valve of FIG. 1A taken along the plane A-A, when the valve closure element is in an open position.

FIG. 2B is a perspective cross-section view of the double-block-and-bleed valve of FIG. 1A taken along the plane B-B, when the valve closure element is in the open position.

FIG. 3A is a perspective cross-section view of the double-block-and-bleed valve of FIG. 1A taken along the plane A-A, when the valve closure element is in a closed position.

FIG. 3B is a perspective cross-section view of the double-block-and-bleed valve of FIG. 1A taken along the plane B-B, when the valve closure element is in the closed position.

FIG. 4 is a flowchart illustrating a method of regulating fluid flow through a fluid system.

### DETAILED DESCRIPTION

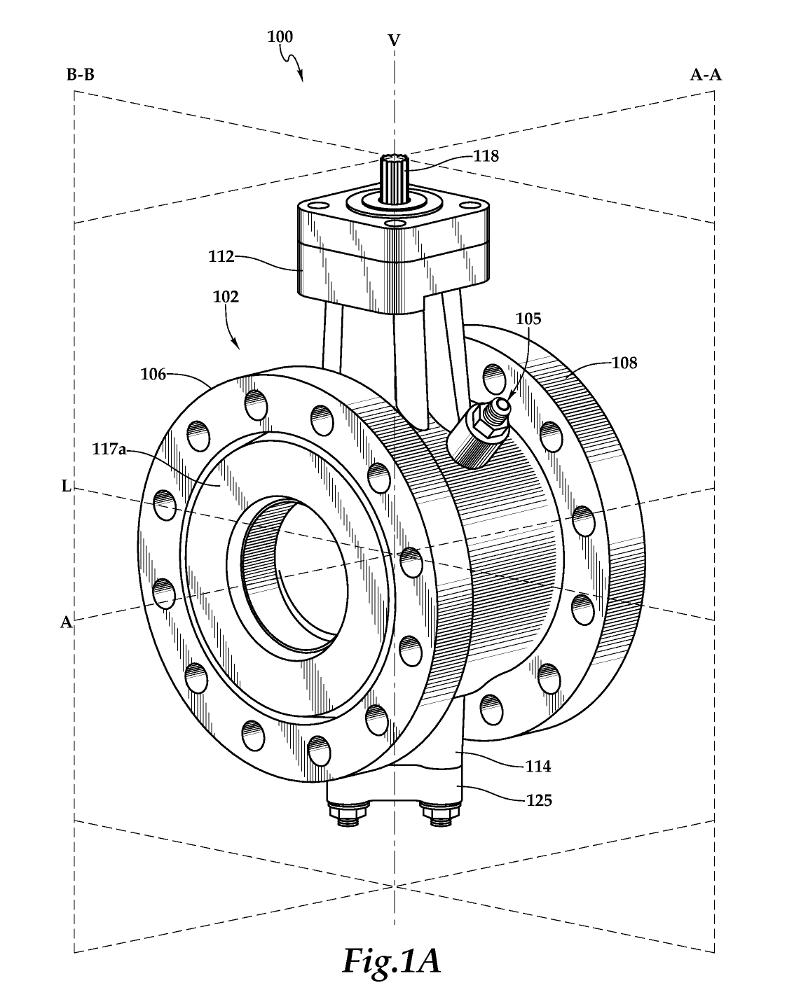

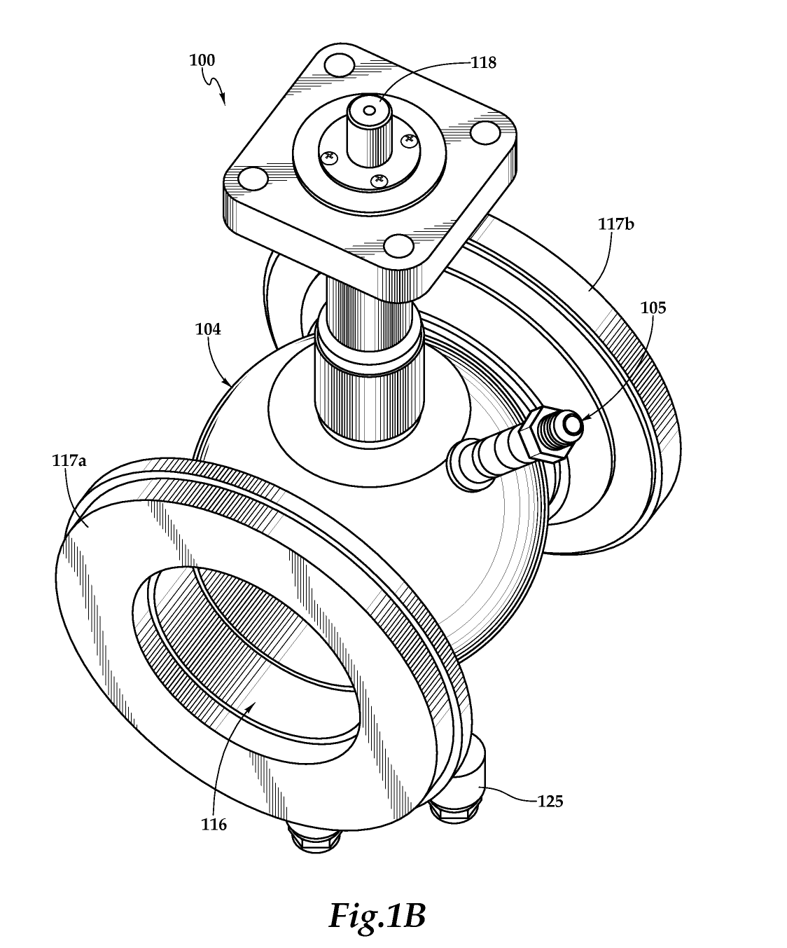

FIGS. 1A and 1B provide perspective views of an exemplary double-block-and-bleed (“DBB”) valve 100. The DBB valve 100 features a single, dual seated ball valve designed to bleed off residual pressure and/or fluid leakage when a valve closure element 104 moved to a closed position. This configuration enables a double-block-and-bleed functionality to be accomplished with a single valve instead of three (as is the case in many conventional arrangements). One or more of the following advantages may be achieved by the apparatus, systems, and methods described below: increased system reliability due to elimination of two valves and their associated failure propensity (vent valves have been identified as a component with particularly poor reliability in conventional block-and-bleed valves); reduced system pressure drop; reduced system piping and fittings; reduced input/output control requirements for valve operation; and/or lower requirements for valve operation.

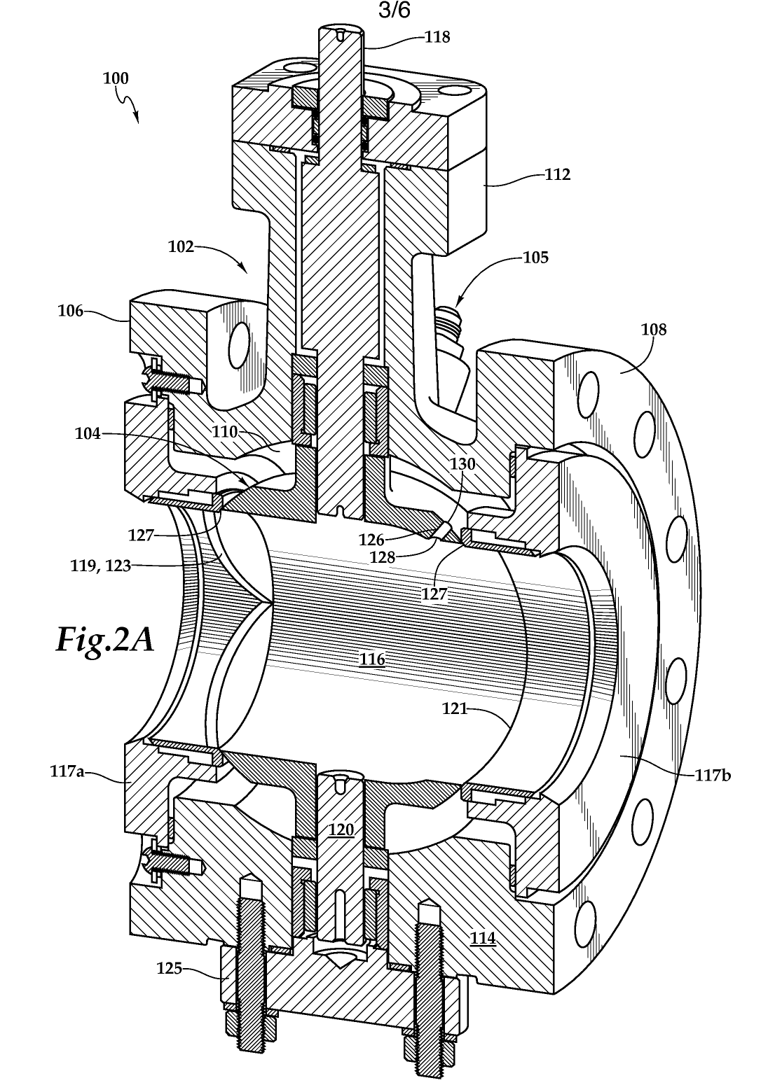

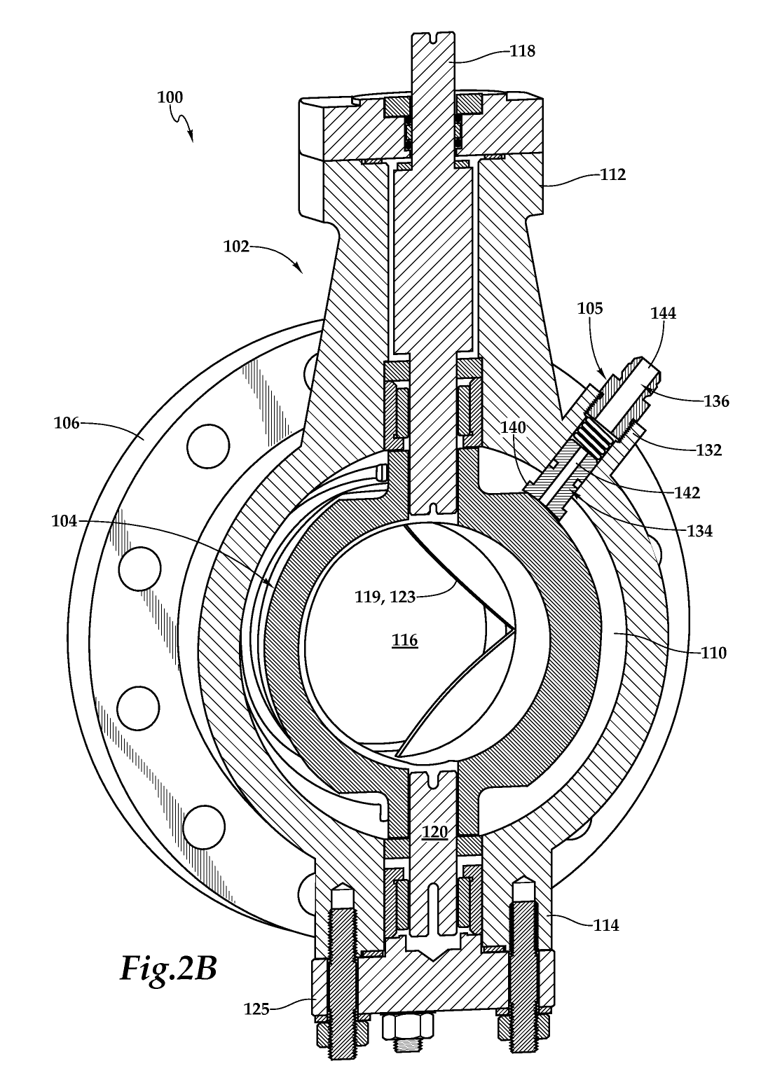

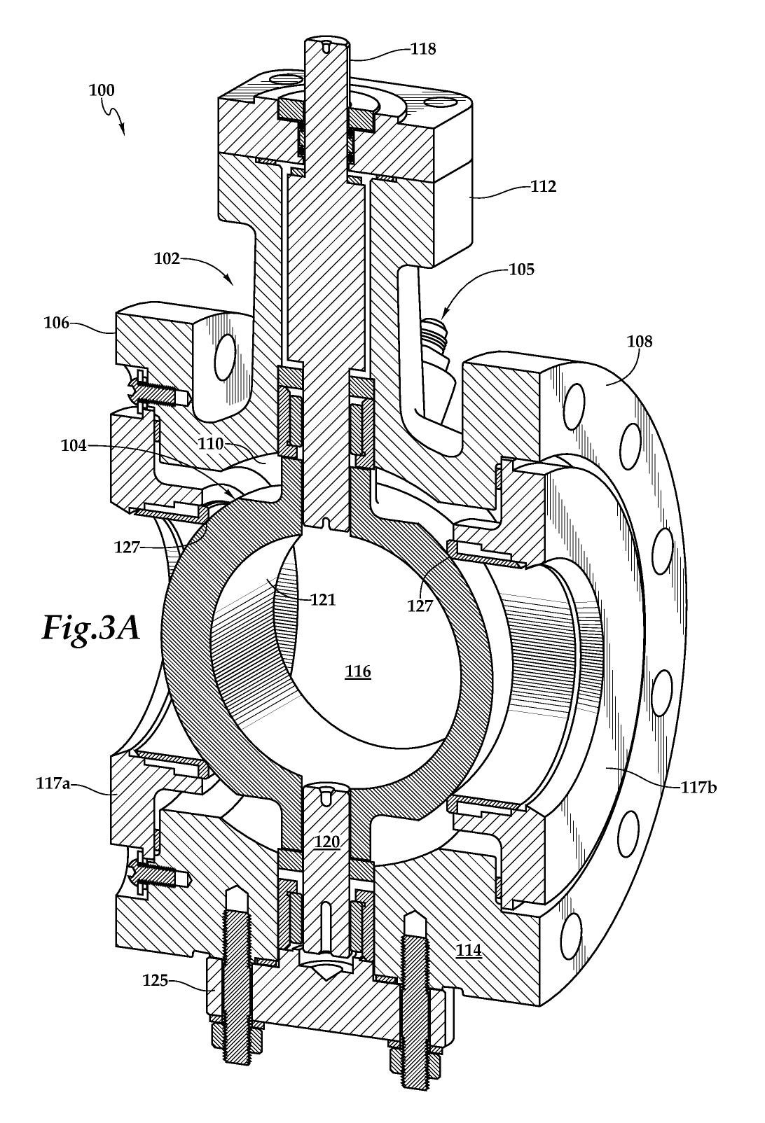

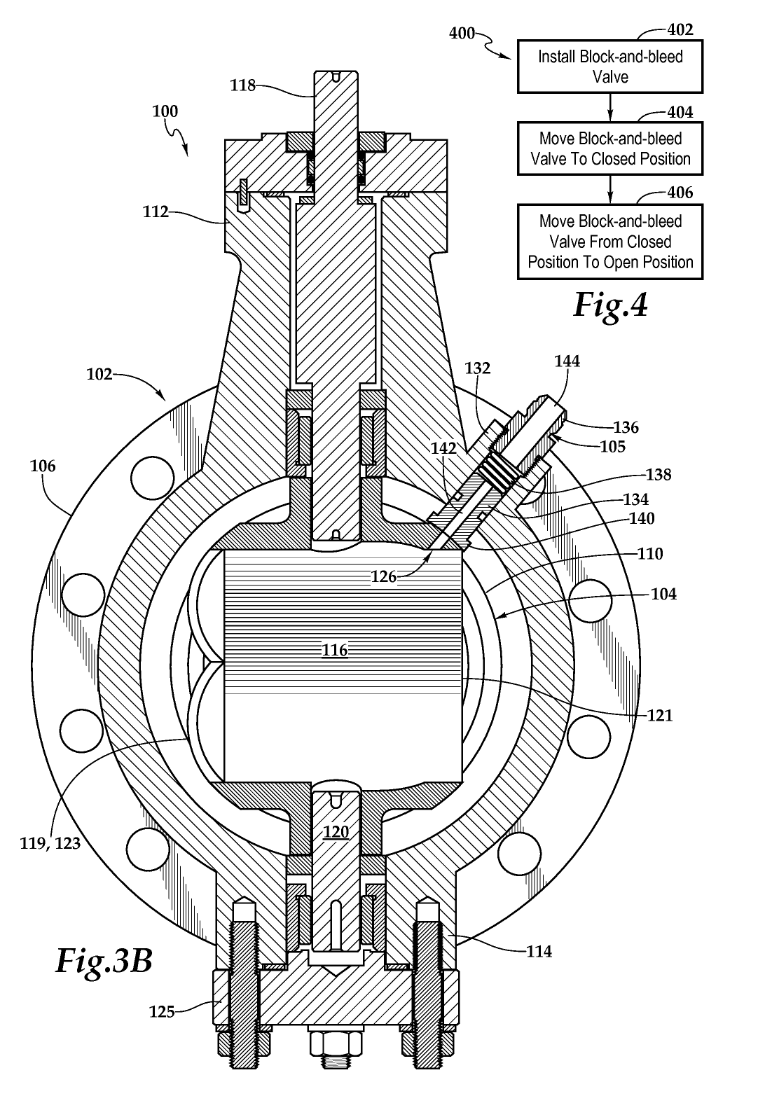

The DBB valve 100 features a valve body 102, the valve closure element 104, and a vent port 105. The various components of the DBB valve 100 are aligned along a vertical axis V”, a lateral axis “L”, and an axial axis “A”. As described in detail below, the valve closure element 104 is generally spherical and rotatably movable relative to the valve body 102 between an open position (see FIGS. 2A and 2B) and a closed position (see FIGS. 3A and 3B). In this example, the vent port 105 is operable to bleed fluid from the valve body 102 only when the valve closure element is in the closed position.

The valve body 102 includes an inlet port 106, an outlet port 108, and an interior chamber 110 located between the two ports. The inlet port 106, outlet port 108, and interior chamber 110 are aligned with one another along the axial axis “A”. In the implementation illustrated, each of the inlet port 106 and outlet port 108 includes a flanged pipe coupling for connecting to upstream and downstream pipe sections (not shown). It will be understood that other coupling means may be used. When the DBB valve 100 is installed at a pipe connection, fluid enters the valve through the inlet port 106, flows through the interior chamber 110, and exits through the outlet port 108. The valve body 102 further includes a main stem 112 and a secondary stem 114 for receiving rotatable shafts that operate the valve closure element 104 (e.g., drive shaft 118 and support shaft 120 shown, for example, in FIG. 1B).

In this example, the valve closure element 104 is a rounded ball located in the interior chamber 110 of the valve body 102. The valve closure element 104 includes a fluid passage 116 positionable in substantial alignment with the inlet port 106 and outlet port 108 of the valve body 102 relative to the vertical axis “V” when the valve 100 is in an open position. The fluid passage 116 originates at an inlet orifice 119 opening to a central bore traversing through the body of the valve closure element 104 to allow fluid (e.g., gas or liquid) to pass through the valve closure element when the closure element is in an open position, the central bore leading to an outlet orifice 121. When the valve closure element 104 is in an open position (see FIGS. 2A and 2B), the fluid passage 116 is at least partially aligned with the inlet port 106 and the outlet port 108 along the axial axis “A”, such that the inlet orifice 119 is in fluid communication with the inlet port. Thus, the valve closure element 104 can be operated in several opened positions (i.e., a fully open position and a many partially open positions). On the other hand, when the valve closure element 104 is in the closed position (see FIGS. 3A and 3B), the fluid passage 116 is turned away from (e.g., orthogonal to) the inlet port 106 and the outlet port 108 along the axial axis “A”, such that the inlet orifice 119 is substantially sealed from the inlet port.

The outlet orifice 121 defines a circular edge having a diameter matching that of the central bore. The inlet orifice 119 defines a semi-circular edge defining rounded v-notch 123 at its leading side. The “leading side” of the orifice is the side that closes against the valve seat (e.g., valve seat 117a) as the valve closure element is moved to the closed position. The contoured leading edge of the inlet orifice 119 regulates certain flow characteristics of the fluid as it passes through the fluid passage 116, while the valve closure element 104 is operated in the various open positions.

Opposing valve seats 117a and 117b are positioned at the inlet port 106 and outlet port 108, respectively. The valve seats 117a and 117b are located between the valve body 102 and the valve closure element 104, such that a convex outer surface of the valve closure element seals against the valve seats 117a and 117b when the valve closure element is in a closed position. As shown in FIGS. 2A and 3A, the valve seats 117a and 117b are annular components fitted to and sealed against the flanged pipe coupling of the inlet and outlet ports 106 and 108. Each of the valve seats 117a and 117b features an inner peripheral surface 127 conforming to the convex outer surface of the valve closure element 104.

The valve closure element 104 is mounted on a drive shaft 118 housed in the main stem 112 of the valve body 102. The valve closure element 104 is fixedly coupled to the drive shaft 118 (e.g., via mating splines, mechanical fasteners, or other attachment techniques), such that rotation of the drive shaft effects substantially identical rotation of the valve closure element. The drive shaft 118 can be manually, hydraulically, pneumatically, or electrically actuated to operate the valve closure element 104. An idle support shaft 120 housed in the secondary stem 114 of the valve body 102 bears the weight of the valve closure element 104. A base plate 125 coupled to the valve body 102 locates the support shaft 122 relative to the valve closure element 104. Each of the drive shaft 118 and the support shaft 122 is mounted in the respective stems 112 and 114 by a radial load bearing 124.

The valve closure element 104 features a vent channel 126 (See FIG. 2A). The vent channel 126 includes an inlet 128 open to the fluid passage 116, and extends radially through the body of the valve closure element 104 to an outlet 130. The outlet 130 of the vent channel 126 is located in the element 104 so as to be positionally in alignment with the vent port 105 when the valve closure element 104 is rotated to the closed position. In this example, the vent port 105 includes a radial passage 132 traversing an outer wall of the valve body 102, a vent shoe 134, an external fitting 136, and a biasing member 138 (see FIG. 3B).

The vent shoe 134 projects through the radial passage 132 and into the interior chamber 110. A flanged sole 140 of the vent shoe 134 bears against the convex outer surface of the valve closure element 104. When the vent channel 126 of the valve closure element 104 is aligned with the vent port 105 (i.e., when the valve closure element 104 is in the closed position), the outlet 130 of the vent channel opens to a central bore 142 of the vent shoe 134, which allows fluid to “vent” or “bleed” from the fluid passage 116. In particular, fluid flows from the fluid passage 116, through the vent channel 126, through the central bore 142 of the vent shoe 134, and through a central bore 144 of the external fitting 136. The biasing member 138 is disposed between the vent shoe 135 and the external fitting 136. Thus, the biasing member 138 functions as an axial loading spring, urging the vent shoe 134 against the valve closure element 104.

FIG. 4 is a flowchart illustrating a method 400 of regulating fluid flow through a fluid system (e.g., a piping network). A step 402, a block-and-bleed valve is installed at a connection between neighboring sections of pipe. The block-and-bleed valve may be a double-block-and-bleed valve, such as DBB valve 100 described above with reference to FIGS. 1A-3B. That is, the block-and-bleed valve may include a single, dual seated ball valve operable between an open position, where fluid flow through the valve is permitted, and a closed position, where fluid flow through the valve is prevented. The double-block-and-bleed valve is designed to bleed off residual pressure and/or fluid when moved to a closed position. At step 404, the block-and-bleed valve is moved to a closed position, where a fluid passage of the valve closure element is sealed from the input and output ports of the valve body. In the closed position, a vent channel extending radially through the valve closure element is aligned with a vent port of the valve body to allow fluid trapped within the fluid passage of the valve closure element to bleed off. At step 406, the block-and-bleed valve is moved from the closed position to an open position, where the fluid passage of the valve closure element is aligned with the input and output ports of the valve body. In the open position, the vent channel of the valve closure element is moved away from the vent port, which prevents bleeding off of the fluid.

In the foregoing description of the DBB valve 100, various components, such as seals, bearings, fasteners, fittings, etc., may have been omitted to simply the description. However, those skilled in the art will realize that such conventional equipment can be employed as desired. Those skilled in the art will further appreciate that various components described are recited as illustrative for contextual purposes and do not limit the scope of this disclosure.

Further, the use of a reference axes throughout the specification and/or claims is for describing the relative positions of various components of the system, apparatus, and other elements described herein. Unless otherwise stated explicitly, the use of such terminology does not imply a particular position or orientation of any components during operation, manufacturing, and/or transportation.

A number of embodiments of the invention have been described. Nevertheless, it will be understood that various modifications may be made without departing from the spirit and scope of the inventions. For example, the vent elements (e.g., the vent channel and the vent port) can be incorporated in a single-block-and-bleed valve). Further, while the valve closure element set forth above has been shown and described as a rounded ball plug, other suitable configurations of the valve closure elements can also be implemented without departing from the scope of the present disclosure.

What is claimed is:

1. A block valve comprising:
a valve body having an interior chamber between an inlet port and an outlet port, said valve body including a vent port positioned in the valve body; and
a valve closure element located within the chamber, said valve closure element having a fluid passage therethrough, the valve closure element being movable relative to the valve body between a first position, where the fluid passage is at least partially alignable with the inlet port and the outlet port, and a second position, where a sealing surface of the valve closure element seals the inlet port and the outlet port from the chamber, said valve closure element including a vent channel positioned in fluid communication with the vent port and the fluid passage of the valve closure element, the vent channel alignable with the vent port only when the valve closure element is in the second position.

2. The valve of claim 1, wherein the vent port comprises a radial passage extending through an outer wall of the valve body.

3. The valve of claim 2, wherein the vent port further comprises a vent shoe and an external fitting located within the radial passage.

4. The valve of claim 3, wherein, when the valve closure element is in the second position, the vent channel is aligned with collinear bores of the vent shoe and the external fitting.

5. The valve of claim 3, wherein the vent port further comprises a biasing member positioned between the vent shoe and the external fitting, the biasing member urging the vent shoe against an outer surface of the valve closure element.

6. The valve of claim 5, wherein the vent shoe comprises a flanged sole bearing against the outer surface of the valve closure element.

7. The valve of claim 1, wherein valve closure element comprises a rotatable dual-seated ball plug.

8. The valve of claim 1, wherein the vent channel comprises a radial passage extending through an outer wall of the valve closure element.

9. The valve of claim 1, wherein the valve closure element comprises an inlet orifice opening to the fluid passage, the inlet orifice defining a contoured, semi-circular leading edge for regulating flow characteristics of fluid entering the fluid passage.

10. A method of regulating fluid flow in a piping system, the method comprising:
installing a valve in the piping system, the valve including:
a valve body having an interior chamber between an inlet port and an outlet port and a vent port positioned in the valve body,
a valve closure element located within the chamber and having a fluid passage therethrough, and a vent channel in fluid communication with the vent port and the fluid passage of the valve closure element, wherein the valve body is in sealing contact with said pipe; and
moving the valve closure element relative to the valve body from a first position, where the fluid passage is at least partially aligned with the inlet and outlet ports and the vent channel is separated from the vent port, to a second position, where a sealing surface of the valve closure element seals the inlet port and outlet ports from the chamber and the vent channel is in fluid communication with the vent port.

11. The method of claim 10 further including:
flowing fluid trapped within the fluid passage of the valve closure element through the vent channel and vent port to a position outside of the valve body.

12. The method of claim 10, wherein the vent port comprises a radial passage extending through an outer wall of the valve body.

13. The method of claim 12, wherein the vent port further comprises a vent shoe and an external fitting located within the radial passage.

14. The method of claim 13, wherein, when the valve closure element is in the second position, the vent channel is aligned with collinear bores of the vent shoe and the external fitting.

15. The method of claim 13, wherein the vent port further comprises a biasing member positioned between the vent shoe and the external fitting, the biasing member urging the vent shoe against an outer surface of the valve closure element.

16. The method of claim 15, wherein the vent shoe comprises a flanged sole bearing against the outer surface of the valve closure element.

17. The method of claim 10, wherein valve closure element comprises a rotatable dual-seated ball plug.

18. The method of claim 10, wherein the vent channel comprises a radial passage extending through an outer wall of the valve closure element.

19. The method of claim 10, wherein the valve closure element comprises an inlet orifice opening to the fluid passage, and wherein the inlet orifice is contoured for regulating flow characteristics of fluid entering the fluid passage.
